(19) United States
(12) Patent Application Publication
(10) Pub. No.: US 2023/0264374 A1
(43) Pub. Date: Aug. 24, 2023

(54) STRAIGHT RAZOR

(71) Applicant: Ahmon Bryant, Rochester, NY (US)

(72) Inventor: Ahmon Bryant, Rochester, NY (US)

(21) Appl. No.: 17/678,630

(22) Filed: Feb. 23, 2022

(51) Int. Cl. B26B 21/02

(52) U.S. Cl. CPC B26B 21/02

(57) ABSTRACT

A razor comprising a blade connected at one end to a shank, the shank including a substantially circular cross-sectional profile configured to facilitate manipulation of the blade with two or more of a user's fingers.

### BACKGROUND OF THE INVENTION

### 1. The Field of the Invention

The present invention relates to a straight razor. More specifically, the present invention is directed to a straight razor having a shank including a substantially circular cross-sectional profile.

### 2. Background Art

It has long been a common practice to shave facial hair using a straight edge razor. Barbers and individuals have been using such unguarded straight razors to shave hair from the face and other body regions. The hazards of using a straight razor, particularly in the hands of an unskilled user, are well-known and cuts, nicks and scrapes often resulted. This is one of the reasons many individuals over the years have preferred to use the services of a barber to obtain close shaves. In the United States, barbers have long been licensed professionals, and typically were trained in the use and care of a straight razor. Further, through experience, barbers in the United States and around the world have become quite adept at using straight razors. However, even for experienced professionals, the straight razors are still challenging to use and require multiple passes and subtle actions with one's hand and wrist to reach tight but sensitive and sloped areas of an individual's face. Attempts have been made to improve the safety of using straight razors, e.g., in enhancing the grip of a straight razor or to provide shields to avoid inadvertent cutting of an individual's skin.

U.S. Pat. No. 6,438,846 to Alsaifi (Hereinafter Alsaifi) discloses a disposable straight razor including an elongate body; a triple razor blade assembly mounted in the body; the body being molded about the triple razor blade assembly; the triple razor blade assembly extending outwardly from the body a distance of from approximately 0.5 mm to approximately 4 mm; and a cover for the body and the triple razor blade assembly which extends over the body and completely over the triple razor blade assembly. FIG. 9 of Alsaifi discloses a handle having several notches to facilitate one's grip on the straight razor. However, no disclosure of a rounded shank is available in Alsaifi.

There is therefore a need for a razor can be more easily manipulated, a razor which can be manipulated with fingers already used to grasp the razor to create fluid continuous motions in shaving even on an individual's undulating skin surfaces without causing injury to the individual.

### SUMMARY OF THE INVENTION

In accordance with the present invention, there is provided a razor including a blade connected at one end to a shank, the shank including a substantially circular cross-sectional profile configured to facilitate manipulation of the blade with two or more of a user's fingers.

In one embodiment, the razor further includes a housing including an end to which the shank is pivotably connected to enable the blade to be collapsibly storable within the housing. In one embodiment, the blade is a blade fixedly constructed with the shank. In one embodiment, the blade is a replaceable blade. In one embodiment, the razor further includes a tang, the tang configured to be connected to the shank to further enhance manipulation of the razor with one or more of the user's fingers. In one embodiment, a surface of the shank is configured to be textured with a slip resistant texture.

In accordance with the present invention, there is further provided a method for improving the control of a blade of a razor with fingers of a user, wherein the blade is connected to a shank having a lengthwise axis, the method includes disposing a cross-sectional profile of the shank in the shape of substantially a circle such that a rotation about the lengthwise axis of shank can be readily exerted by the fingers of the user.

An object of the present invention is to provide a straight razor having a blade that can be orientated using movements of a user's fingers also used for holding the razor.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a top perspective view of a razor with its blade rotatably removed from its housing.

FIG. 2 is a top perspective view of a razor with its blade rotatably removed from its housing.

FIG. 3 is a diagram depicting a present razor being placed to contact an individual's skin where the razor is to be used for shaving the individual's hair.

FIG. 4 is a diagram depicting a manner in which a present razor is manipulated by its shank to shave an individual's hair.

FIG. 5 a top perspective view of a razor with its blade rotatably removed from its housing and its shank is shown textured with a slip resistant texture.

### PARTS LIST

2—razor, e.g., straight razor
4—shank or handle
6—cross-sectional profile
8—cavity
10—blade
12—replaceable blade
14—finger of user
16—thumb of user
18—skin of user
20—hair of user
22—orientation at which blade contacts user
24—orientation to which blade is adjusted
26—angle of rotation
28—movement of thumb
30—movement of finger
32—direction of rotation
34—tang
36—housing
38—blade carrier
40—slip resistant texture
42—central or lengthwise axis of shank
44—pivot
46—angle of attack
48—angle of attack

### Particular Advantages of the Invention

The present straight razor includes a shank having a cross-sectional area or shape that is circular or round, i.e., a shape that allows its user to manipulate the razor in a manner impossible to be manipulated in a conventional straight razor. On a conventional straight razor having a fixed blade or a replaceable blade, the shank is constructed from a rod or structure having a rectangular cross-sectional profile. This makes twisting of the razor between a user's fingers very awkward and not smooth. This in turn makes it less safe to operate the razor due to the limitation in the user's dexterity in using the razor. The shank of a present razor is rounded off in a tubular or cylindrical fashion. This tubular or cylindrical shape allows the user to roll the shank between the user's fingers which enhances the user's ability in handling and controlling the razor which in turn allows for greater safety in handling the razor.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

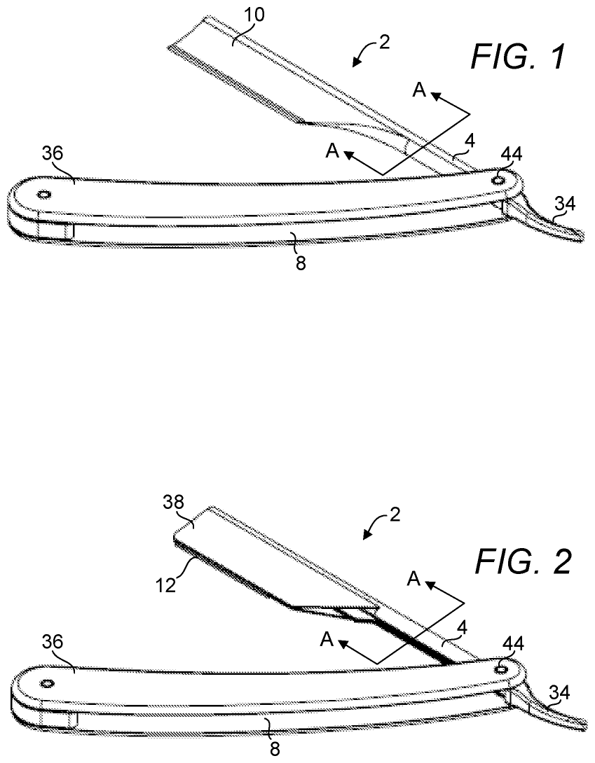

FIG. 1 is a top perspective view of a razor 2 with its blade 10 rotatably removed about a pivot 44 from its housing 36. The razor 2 includes a blade 10 connected at one end to a shank 4. At a second end of the shank 4, the shank 4 extends into a tang 34. The housing 36 is pivotably connected to the shank 4 at a pivot 44 between the shank 4 and the tang 34. The tang 34 serves as a finger gripping bar with which a user can carefully control the blade to give a precise shave. FIG. 2 is a top perspective view of a razor 2 with its blade rotatably removed about a pivot 44 from its housing 36. Here, a replaceable blade 12 is shown attached to a blade carrier 38. Note that the razor shown in FIG. 1 includes a blade 10 fixedly constructed with the shank 4, e.g., as a single unit. The housing 36 includes an end to which the shank 4 is pivotably connected to enable the blade 10, 12 to be collapsibly stored in the cavity 8 of the housing 36.

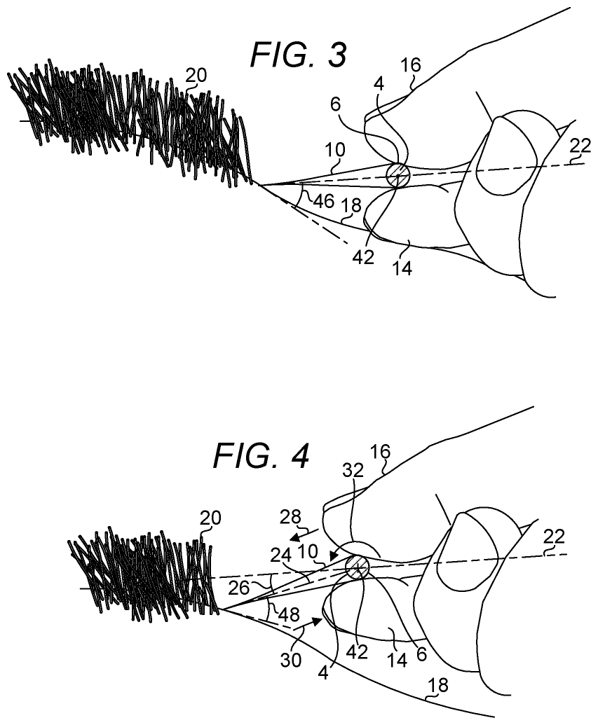

FIG. 3 is a diagram depicting a present razor 2 being placed to contact an individual's skin 18 where the razor 2 is to be used for shaving the individual's hair 20. FIG. 4 is a diagram depicting a manner in which a present razor 2 is manipulated by its shank 4 to shave an individual's hair 20. The shank 4 is shown as a cross-sectional profile 6 that results if a cross-section is taken along line A-A of FIG. 1 or FIG. 2. It shall be noted that the cross-sectional profile 6 resembles and is substantially a circle or substantially round. With the shape of the profile, a user can improve his or her control or manipulation of the blade 10, 12 simply by rotating the shank 4 with the grip placed on the shank 4 with a finger 14 and a thumb 16 of the user to adjust the angle of rotation 26 or orientation of the shank 4 about the central or lengthwise axis 42 of the shank 4.

The diagram shown in FIG. 4 represents a result from the act of shaving from right to left following the placement of the blade 10 shown in FIG. 3. The orientation of the blade 10 is initially disposed in orientation 22 before an individual's hair 20 starts to be shaved. It shall be noted that by movements 28, 30 of the thumb 16 and finger 14, a rotation of the shank 4 is caused in direction 32 to alter the orientation of the shank 4 about the lengthwise axis 42 to orientation 24. It shall also be noted that the angle of attack of the blade with respect to the user's skin has been altered from angle of attack 46 to angle of attack 48 by simply moving the fingers 14, 16 without requiring other movements by the user, e.g., twisting of the user's wrist, etc. The user can therefore adjust the angle of attack of the blade 10 on-the-fly to avoid injuring the individual while still allowing the blade 10 to function well, i.e., to sever the individual's hair as the individual's skin profile may change from one location to another as shown in FIGS. 3 and 4.

It can therefore be summarized that, in order to improve the control of a blade of a razor with fingers of a user, wherein the blade is connected to a shank having a lengthwise axis, the method includes disposing a cross-sectional profile of the shank in the shape of substantially a circle such that a rotation about the lengthwise axis of shank can be readily exerted by the fingers of the user.

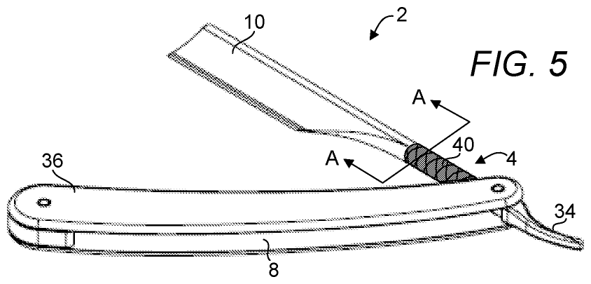

FIG. 5 a top perspective view of a razor with its blade 10 rotatably removed from its housing and its shank is shown textured with a slip resistant texture 40, e.g., patterns pressed or stamped into a surface of the shank 4. The shank and blade of conventional razors are typically constructed from a polished metal. These surfaces tend to be slippery and unstable when grasped with user's fingers, making shaving operations of the conventional razors less safe. Applicant discovered that by disposing a slip resistant texture on the shank 4, slippages while grasping of the razor at the shank 4 and rotating the shank 4 can be eliminated.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A razor comprising a blade connected at one end to a shank, said shank comprising a substantially circular cross-sectional profile configured to facilitate manipulation of said blade with two or more of the user's fingers.

2. The razor of claim 1, further comprising a housing comprising an end to which said shank is pivotably connected to enable said blade to be collapsibly storable within said housing while said razor is not in use.

3. The razor of claim 1, wherein said blade is a blade fixedly constructed with said shank.

4. The razor of claim 1, wherein said blade is a replaceable blade.

5. The razor of claim 1, further comprising a tang, said tang configured to be connected to said shank to further enhance manipulation of the razor with one or more of the user's fingers.

6. The razor of claim 1, wherein a surface of said shank is configured to be textured with a slip resistant texture.

7. A razor comprising:
(a) a blade;
(a) a shank to which said blade is connected, said shank comprising a substantially circular cross-sectional profile configured to facilitate manipulation of said blade with two or more of a user's fingers; and
(c) a housing comprising an end to which said shank is pivotably connected to enable said blade to be collapsibly storable within said housing while said razor is not in use.

8. The razor of claim 7, wherein said blade is a blade fixedly constructed with said shank.

9. The razor of claim 7, wherein said blade is a replaceable blade.

10. The razor of claim 7, further comprising a tang, said tang configured to be connected to said shank to further enhance manipulation of the razor with one or more of the user's fingers.

11. The razor of claim 7, wherein a surface of said shank is configured to be textured with a slip resistant texture.

12. A method for improving the control of a blade of a razor with fingers of a user, wherein the blade is connected to a shank having a lengthwise axis, said method comprising disposing a cross-sectional profile of the shank in the shape of substantially a circle such that a rotation about the lengthwise axis of shank can be readily exerted by the fingers of the user.

13. The method of claim 12, wherein the razor comprises a housing comprising an end to which said shank is pivotably connected to enable said blade to be collapsibly storable within said housing while said razor is not in use.

14. The method of claim 12, wherein the blade is a blade fixedly constructed with the shank.

15. The method of claim 12, wherein the blade is a replaceable blade.

16. The method of claim 12, wherein the razor further comprises a tang, the tang configured to be connected to the shank to further enhance manipulation of the razor with one or more of the user's fingers.

17. The method of claim 12, wherein a surface of the shank is configured to be textured with a slip resistant texture.
